(19) United States
(12) Patent Application Publication
(10) Pub. No.: US 2018/0199536 A1
(43) Pub. Date: Jul. 19, 2018

(54) LITTER BOX LINER

(71) Applicant: Thomas Anthony Torralbas, Perrysburg, OH (US)

(72) Inventor: Thomas Anthony Torralbas, Perrysburg, OH (US)

(21) Appl. No.: 15/873,777

(22) Filed: Jan. 17, 2018

Related U.S. Application Data
(60) Provisional application No. 62/447,326, filed on Jan. 17, 2017.

(51) Int. Cl. A01K 1/01

(52) U.S. Cl. CPC A01K 1/011

(57) ABSTRACT

A litter box liner disposed within a litter box. The litter box liner includes a sheet made of a pliable material. The sheet includes an outer edge. Handles include an elongated tube and a clip. The outer edge of the sheet wraps around the elongated tube and the clip releasably secures the outer edge of the sheet to the elongated tube.

### CROSS-REFERENCE TO RELATED APPLICATION

This application claims the benefit of priority of U.S. provisional application No. 62/447,326, filed Jan. 17, 2017, the contents of which are herein incorporated by reference.

### BACKGROUND OF THE INVENTION

The present invention relates to litter box liner and, more particularly, to an improved litter box liner that prevents litter boxes from getting dirty.

A litter box is an indoor feces and urine collection box for cats that are permitted to freely roam within a home but who cannot or do not always go outside to relieve themselves. Litter boxes are often difficult to clean. If the box does not contain a liner, the litter clumps up and hardens in the corners of the litter box, which makes it difficult to fully clean the box. If a liner is used, the litter may still be difficult to fully clean from the corners and crevices. Additionally, the liner frequently tears, allowing the dirty litter to reach the litter box. Further, the liner needs to be replaced about every two weeks, adding cost and frustration to maintaining a clean litter box.

As can be seen, there is a need for an improved liner that prevents a litter box from getting dirty.

### SUMMARY OF THE INVENTION

In one aspect of the present invention, a litter box liner comprises: a sheet made of a pliable material and having an outer edge; and a plurality of handles, each of the plurality of handles comprising: an elongated tube; and a clip, wherein the outer edge of the sheet wraps around the elongated tube and the clip releasably secures the outer edge of the sheet to the elongated tube.

In another aspect of the present invention, a cat litter box apparatus comprises: a litter box comprising a base and a pair of opposing end walls and a pair of opposing sidewalls extending vertically from the base; a sheet made of a pliable material and having an outer edge forming four corners; and four handles, each of the four handles comprising: an elongated tube; and a clip, wherein each of the four corners wraps around a corresponding elongated tube of the four handles, wherein a corresponding clip of the four handles releasably secures a corresponding corner to the corresponding elongated tube.

These and other features, aspects and advantages of the present invention will become better understood with reference to the following drawings, description and claims.

### BRIEF DESCRIPTION OF THE DRAWINGS

FIG. 1 is a perspective view of an embodiment of the present invention shown in use;

FIG. 2 is an exploded view of an embodiment of the present invention;

FIG. 3 is a detail perspective view of an embodiment of the present invention;

FIG. 4 is a detail exploded view of an embodiment of the present invention;

FIG. 5 is a detail exploded view of an embodiment of the present invention;

FIG. 6 is a detail perspective view of an embodiment of the present invention;

FIG. 7 is a section detail view of the present invention taken along line 7-7 in FIG. 6;

FIG. 8 is a section detail view of the present invention taken along line 8-8 in FIG. 1;

FIG. 9 is a section detail view of an embodiment of the present invention in use;

FIG. 10 is a section detail view of an embodiment of the present invention in use;

FIG. 11 is a section detail view of an embodiment of the present invention in use;

FIG. 12 is a section detail view of an embodiment of the present invention in use; and

FIG. 13 is a section detail view of an embodiment of the present invention in use.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

The present invention includes a litter box lining system including handles that allows a user to stretch and re-position the liner in order to remove the litter from the litter box. This system uses a liner that is thicker than a normal litter box liner, making it durable to last for over six months. For example, the liner may be about four to eight times thicker, such as about six times thicker than your average liner. The handles allow the user to lift, shift, and shake the litter. The process of lifting and moving the litter allows the user to ensure that the liner is accessible and cleaned. Additionally, the handles allow the user to clean the litter faster and more efficiently. By moving and flipping the litter, all the cat waste is positioned on top of the litter and thereby easier to clear from the litter. Further, by using a flat liner, there are no edges or corners to clean.

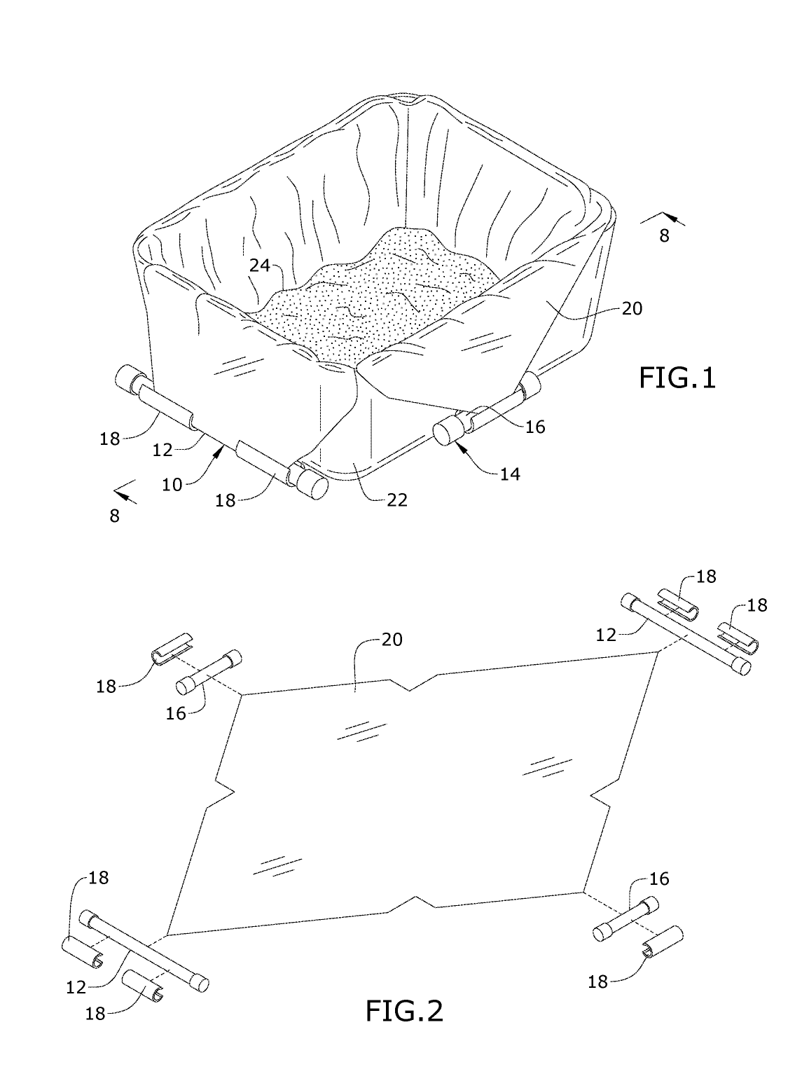

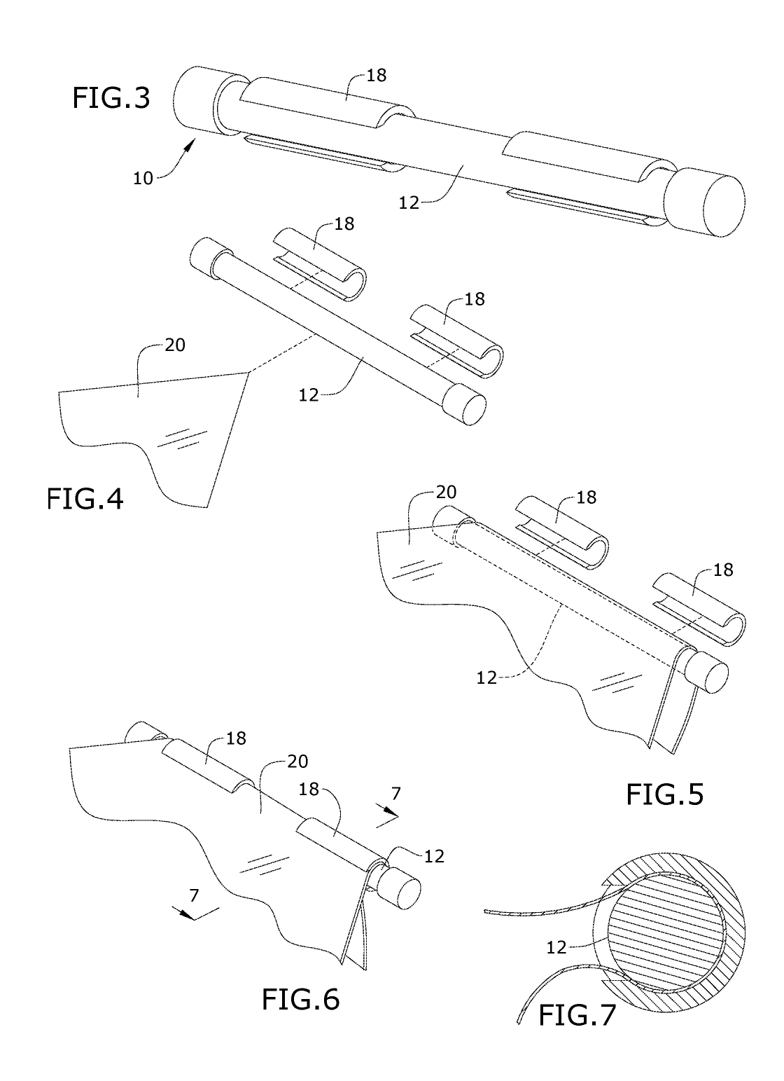

Referring to FIGS. 1 through 7, the present invention includes a litter box liner. The litter box liner includes a sheet 20 made of a pliable material. The sheet 20 includes an outer edge. The present invention further includes a plurality of handles 10, 14. Each of the handles 10, 14 include an elongated tube 12, 16 and a clip 18. The outer edge of the sheet wraps 20 around the elongated tube 12, 16 and the clip 18 releasably secures the outer edge of the sheet 20 to the elongated tube 12, 16.

The clips 18 of the present invention may include an elongated C-shape and be made of a resilient flexible material, such as plastic. In such embodiments, the open side of the C-shaped clip 18 may be pushed over the elongated tube 12, 16. The resiliently flexible arms expand over the elongated tube 12, 16 and then compress once surrounding the elongated tube 12, 16, thereby releasably securing the clips 18 to the elongated tuber 12, 16.

As mentioned above, the sheet 20 is made of a pliable material, such as a sheet of flexible and bendable polymer. The sheet 20 is pliable enough to wrap around the elongated tubes 12, 16. The outer edge of the sheet 20 includes a first side edge opposite a second side edge and a front edge opposite a rear edge. The sheet 20 further includes four corners where the edges meet. In certain embodiments, the present invention may include four handles 10, 14. Each of the four handles 10, 14 is releasably secured to a corresponding corner of the four corners.

In certain embodiments, the handles 10, 14 may include long handles 10 and short handles 14. The long handles 10 include a long elongated tube 12 and the short handles 14 include a short elongated tube 16. In such embodiments, two clips 18 may be used to secure the edge of the sheet 20 to the long handles 12. In such embodiments, the pair of long handles 10 are releasably secured to first opposing corners of the four corners and the pair of short handles 14 are releasably secured to a second opposing corners of the four corners.

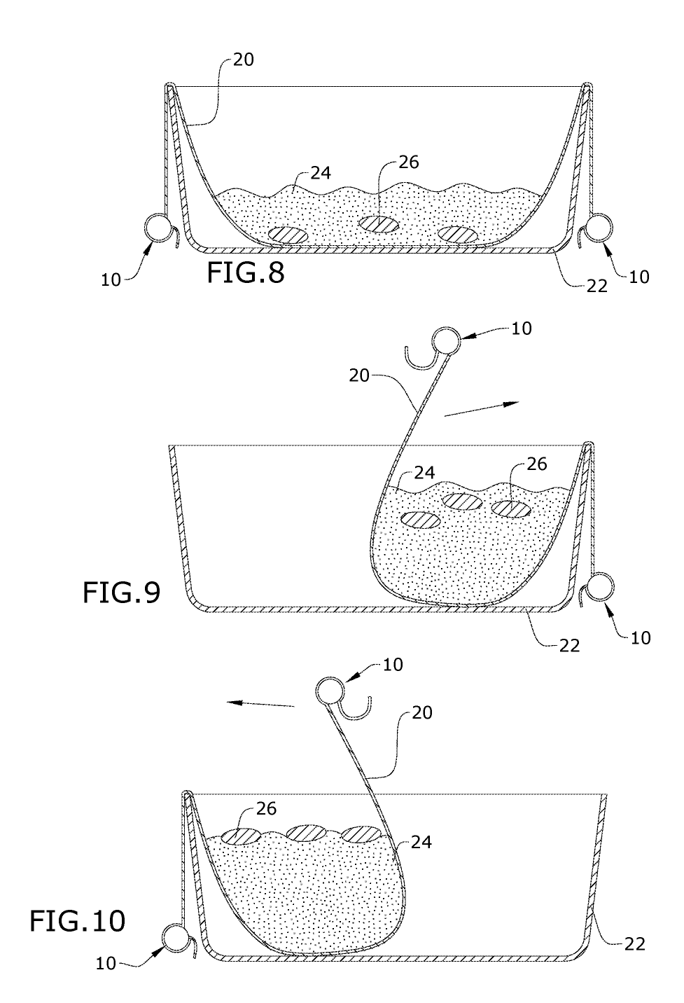

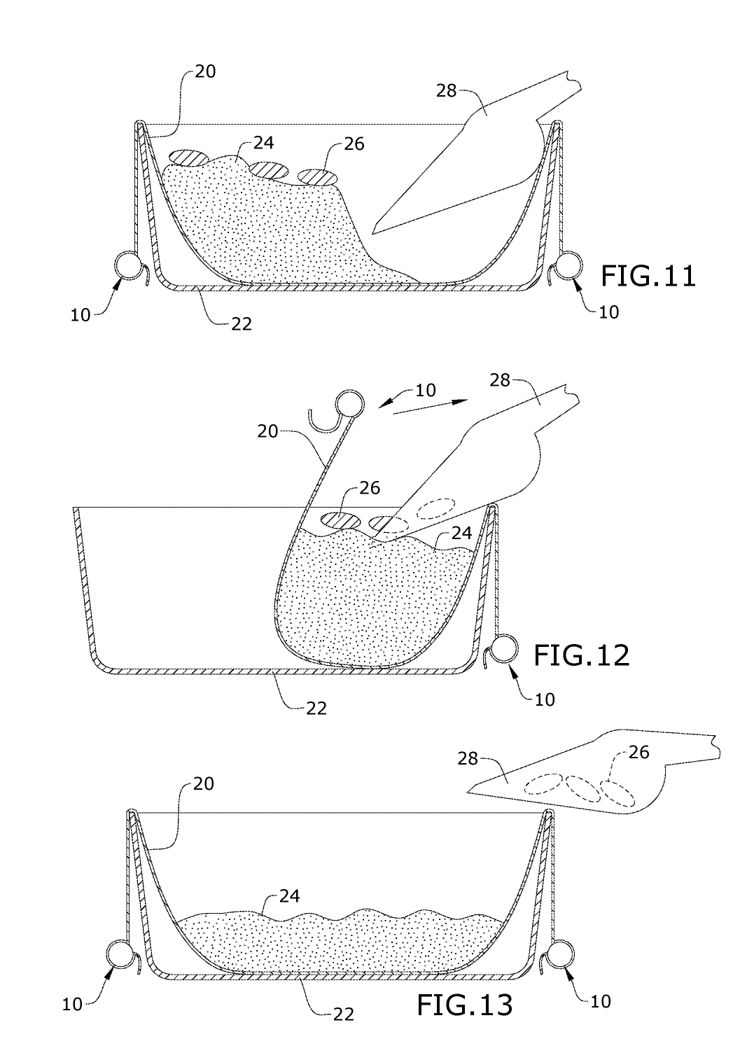

Referring to FIGS. 8 through 13, the litter box 22 is prepped for everyday use by placing the sheet 20 inside of the litter box 22. The short handles 14 are connected to the sheet 20 and placed on the long side of the box 22 to hold down the sheet 20. The long handles 10 are connected to the sheet 20 and left hanging on the short ends of the box 22. A length of the long handles 10 may be equal to or longer than a width of the litter box 22. When the box 22 is ready for cleaning, the user removes the short handles 14. Then by lifting the left long handle 10, the litter 24 shifts to the right. Then repeat this process for the right long handle 10 to shift the litter 24 to the left. This process causes any stuck or caked on waste 26 to become dislodged and become completely covered with litter 24. Repeat as needed, depending on the condition of the litter 24. When the waste 26 is completely dislodged and covered, place the scooper 28 into the empty side of the litter box 22, then by lifting the alternate long handle 10 the litter 24 is pushed into the scooper 28. Lift and sift the scooper 28 removing the waste 26. Place the long handles 10 back to hanging on the short ends of the litter box 22. With the base of the scooper 28, spread the remaining clean litter 24 back in place, and attach the short handles 14 to keep the sheet 20 in place. The system is ready for everyday use again.

It should be understood, of course, that the foregoing relates to exemplary embodiments of the invention and that modifications may be made without departing from the spirit and scope of the invention as set forth in the following claims.

What is claimed is:

1. A litter box liner comprising:
a sheet made of a pliable material and having an outer edge; and
a plurality of handles, each of the plurality of handles comprising:
an elongated tube; and
a clip, wherein
the outer edge of the sheet wraps around the elongated tube and the clip releasably secures the outer edge of the sheet to the elongated tube.

2. The litter box liner of claim 1, wherein the clip comprises a C-shape.

3. The litter box liner of claim 2, wherein the C-shape is an elongated C-shape.

4. The litter box liner of claim 1, wherein the outer edge comprises a first side edge opposite a second side edge and a front edge opposite a rear edge, wherein the sheet comprises four corners where the edges meet.

5. The litter box liner of claim 4, wherein the plurality of handles comprises four handles, wherein each of the four handles is releasably secured to a corresponding corner of the four corners.

6. The litter box liner of claim 5, wherein the four handles comprises a pair of long handles each comprising a long elongated tube and a pair of short handles each comprising a short elongated tube.

7. The litter box liner of claim 6, wherein the pair of long handles are releasably secured to a first opposing corners of the four corners and the pair of short handles are releasably secured to a second opposing corners of the four corners.

8. A cat litter box apparatus comprising:
a litter box comprising a base and a pair of opposing end walls and a pair of opposing sidewalls extending vertically from the base;
a sheet made of a pliable material and having an outer edge forming four corners; and
four handles, each of the four handles comprising:
an elongated tube; and
a clip, wherein
each of the four corners wraps around a corresponding elongated tube of the four handles, wherein a corresponding clip of the four handles releasably secures a corresponding corner to the corresponding elongated tube.

9. The litter box liner of claim 8, wherein the clip comprises a C-shape.

10. The litter box liner of claim 9, wherein the C-shape is an elongated C-shape.
